(19) United States
(12) Patent Application Publication
(10) Pub. No.: US 2023/0177529 A1
(43) Pub. Date: Jun. 8, 2023

(54) SYSTEM AND METHOD FOR MERGING A BINARY MULTI-LEVEL MARKETING SYSTEM INTO A MULTILINE MULTI-LEVEL MARKETING SYSTEM

(71) Applicant: Fred Cooper, Farmington, UT (US)

(72) Inventor: Fred Cooper, Farmington, UT (US)

(21) Appl. No.: 17/867,320

(22) Filed: Jul. 18, 2022

Related U.S. Application Data
(60) Provisional application No. 63/222,752, filed on Jul. 16, 2021.

(51) Int. Cl. G06Q 30/0201

(52) U.S. Cl. CPC G06Q 30/0201

(57) ABSTRACT

Disclosed herein is a system and method to any existing binary MLM to be merged into a multi-line MLM system. Further the existing MLM members have full access to the multi-line MLM commission structure, for example, a member of a binary MLM will maintain their existing lines and downlines and may now add a third, fourth, fifth, etc. line.

### CROSS-REFERENCE TO RELATED APPLICATION

The present application claims the priority benefit of U.S. provisional application No. 63/222,752 filed Jul. 16, 2021, the disclosure of which is incorporated herein by reference.

### FIELD OF THE DISCLOSURE

The present disclosure is generally related to merging multi-level marketing systems.

### BACKGROUND

MLM companies are defined by a commission structure that is multi-level, such that a commission is payed to at least one member above the member who made a sale or purchase. However, there are multiple kinds of commission structures, for example, binary, matrix, or Binary. The problem is that merging these companies while maintaining the integrity of the existing commission tree has been unsuccessful when the two companies do not have the same kind of commission structure. Usually when companies with a different commission structure do merge, the two commission trees are simply kept separate and retain their traits and commission rates. Therefore, members of a binary commission structure must continue to build that structure even if other members of the now merged company are Binary. If the merged company does decide to attempt to merge the commission trees, it often ends with members feeling disoriented by changes in position and can bring sudden changes in what was steady income which is very upsetting to members when the change results in a loss of income. There is a need for existing MLM companies to merge without having to either continue to keep the two companies separate or upset members by rearranging the existing commission structures.

### DESCRIPTIONS OF THE DRAWINGS

FIG. 1: Illustrates a Multi-Level Marketing Merger System.

FIG. 2: Illustrates a Multiline MLM Multiline User Database.

FIG. 3: Illustrates a Multiline MLM Sales Database.

FIG. 4: Illustrates a Multiline MLM Commission Module.

FIG. 5: Illustrates a Multiline MLM Commission Rules Database.

FIG. 6: Illustrates a Multiline MLM Commission Database.

FIG. 7: Illustrates a Multiline MLM Additional Line Module.

FIG. 8: Illustrates a Multiline MLM Merger Module.

FIG. 9: Illustrates a Binary MLM Base Module.

FIG. 10: Illustrates a Binary MLM Binary User Database.

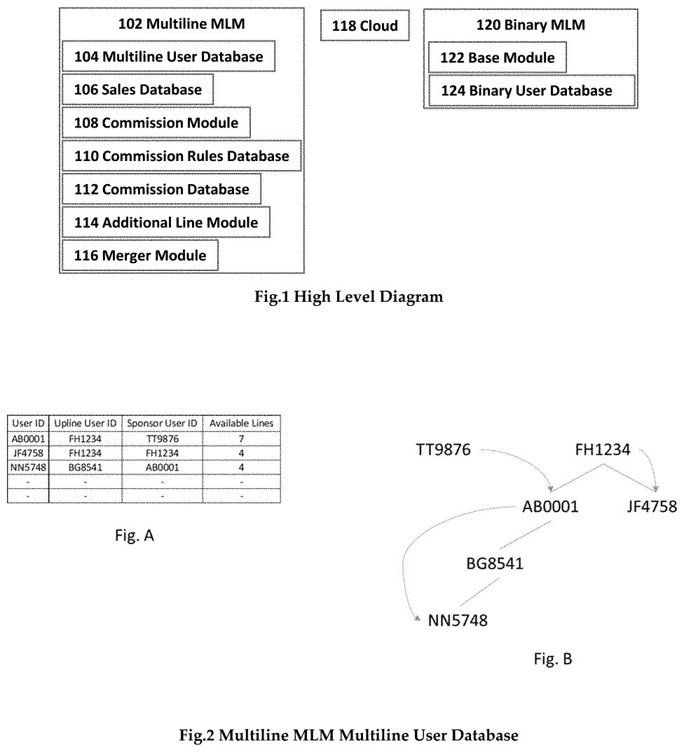

### DETAILED DESCRIPTION

This is a system for a Multi-Level Marketing Merger System. This system comprises of a 102 Multiline MLM which is a distribution organization characterized by a multi-level payment structure where in each user of the organization is a distributor and pays commission to the user or users above them in the organization's structure, and which allows users to have an infinite amount of lines, which are users below them paying commission, and the users below those users, and so on, in an embodiment these additional lines may only be added once the users initial lines meet a threshold volume or commission amount, at element 102. A 104 Multiline MLM Multiline User Database which contains information on user's position in the Multiline MLM commission structure, who enrolled or sponsored the user in the Multiline MLM, and how many lines the user is currently allowed, at element 104. A 106 Multiline MLM Sales Database which contains data on sales made by users, which is used by the 108 Multiline MLM Commission Module to pay commissions to other users, at element 106. A 108 Multiline MLM Commission Module which calculates commission based on new sales data in the 106 Multiline MLM Sales Database and stores that commission in the MLM Commission Database, in some embodiments the 108 Multiline MLM Commission Module may also pay users directly, at element 108. A 110 Multiline MLM Commission Rules Database which stores commission rules which are used by the 108 Multiline MLM Commission Module to determine commissions, at element 110. A 112 Multiline MLM Commission Database which stores commissions calculated by the 108 Multiline MLM Commission Module which are then used by the 114 Multiline MLM Additional Line Module to determine if the user qualifies for an additional line, in some embodiments this data may be used by another module to pay commissions to users, at element 112. A 114 Multiline MLM Additional Line Module which determines if the user has met the threshold commission value on their existing lines based on data from the Multiline MLM Commissions Database and if so adds an additional line to the number of lines that user is allowed, at element 114. A 116 Multiline MLM Merger Module which receives data from the 124 Binary MLM Binary User Database via thee 122 Binary MLM Base Module and stores that data in the 104 Multiline MLM Multiline User Database, at element 116. The 118 Cloud or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party 118 Clouds enable organizations to focus on their core businesses instead of expending resources on computer infrastructure and maintenance, at element 118. A 120 Binary MLM which is a distribution organization characterized by a multi-level payment structure where in each user of the organization is a distributor and pays commission to the user or users above them in the organization's structure, and which allows users to have an infinite amount of lines, which are users below them paying commission, and the users below those users, etc. until a certain depth of users is reached, for example if user 1 is above user 2, who is above user 3, who is above user 4, who is above user 5, etc. then users 2,3, and 4 must pay commissions to user 1, but users 5, 6, 7, etc. do not pay commissions to user 1, at element 120. A 122 Binary MLM Base Module which extracts data from the 124 Binary MLM Binary User Database and sends that data to the 116 Multiline MLM Merger Module to be stored in the 104 Multiline MLM Multiline User Database, at element 122. A 124 Binary MLM Binary User Database which contains information on user's position in the Binary MLM commission structure, who enrolled or sponsored the user in the Binary MLM, and how many lines the user currently has, at element 124.

Functioning of the 104 Multiline User Database will now be explained with reference to FIG. 2. The 104 Multiline MLM Multiline User Database contains a user ID, for example, AB0001, information on user's position in the 102 Multiline MLM commission structure, for example the user ID of the user above them in the commission structure, for example, FH1234, who enrolled or sponsored the user in the 102 Multiline MLM, for example, user ID TT9876, and how many lines the user is currently allowed, for example, 7, users are assigned a default number of lines when they join the 102 Multiline MLM, users that were merged from another MLM, for example, *the 120 Binary MLM will come into the 102 Multiline MLM with at least the number of lines they had under their old MLM structure, in an embodiment the default number of lines is 4, FIG. 2B shows a possible commission structure based on the data in FIG. 2A, wherein the straight lines indicate an upline/downline relationship between two users and a curved, arrowed line indicates that the user the arrow points to was sponsored by the user the line originates from, more lines and users may exist than are shown, element 200.

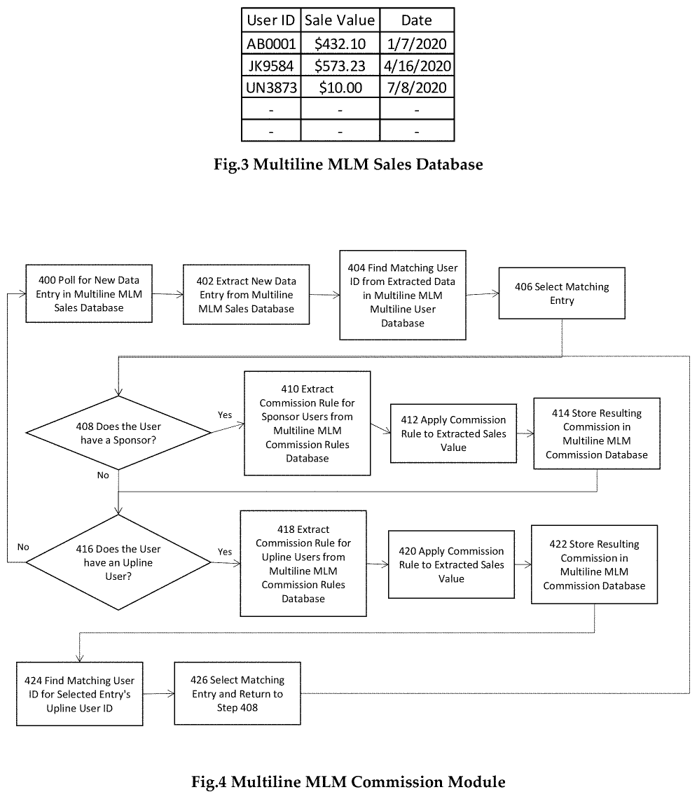

Functioning of the 106 Multiline MLM Sales Database will now be explained with reference to FIG. 3. The 106 Multiline MLM Sales Database contains data on sales made by users, which includes a user ID, for example, AB0001, a sale value, for example, $432.10, and a transaction date, for example, Jan. 7, 2020, which is used by the 108 Multiline MLM Commission Module to pay commissions to other users, in some embodiments the database may include more sales data such as the seller's ID if applicable, item IDs of the items sold, volume sold, payment method and data, etc., element 300.

Functioning of the 108 Multiline MLM Commission Module will now be explained with reference to FIG. 4. The process begins with the 108 Multiline MLM Commission Module polling for a new data entry in the 106 Multiline MLM Sales Database, for example, when a sale is made by a user, at step 400. The 108 Multiline MLM Commission Module extracts the new data entry from the 106 Multiline MLM Sales Database which includes at least a user ID, sales value, and date, at step 402. The 108 Multiline MLM Commission Module searches for a User ID in the 104 Multiline MLM Multiline User Database that matches the user ID extracted from the 106 Multiline MLM Sales Database, for example if the extracted user ID had a value of “AB0001” then the 108 Multiline MLM Commission Module will search the 104 Multiline MLM Multiline User Database for a value of “AB0001” in the “User ID” category, at step 404. The 108 Multiline MLM Commission Module selects the entry in the 104 Multiline MLM Multiline User Database with a matching user ID value, at step 406. The 108 Multiline MLM Commission Module determines if the user has a sponsor by checking the entry for a value in the “Sponsor User ID” category, if there is no value, or the value does not correspond to a user ID then the 108 Multiline MLM Commission Module will skip to step 416, at step 408. If there is a value that corresponds to a user ID in the “Sponsor User ID” category, the 108 Multiline MLM Commission Module extracts the commission rule from the 110 Multiline MLM Commission Rule Database for sponsor users, at step 410. The 108 Multiline MLM Commission Module applies the extracted commission rule to the sales value extracted from the 106 Multiline MLM Sales Database, for example if the rule is 10% commission for sponsors and the sales value is $300, then $300 will be multiplied by 10% to get $30 which is the commission payable to the sponsor, in an embodiment the sponsor may be paid directly by the 108 Multiline MLM Commission Module after this step, at step 412. The 108 Multiline MLM Commission Module stores the resulting commission in the 112 Multiline MLM Commission Database along with the user ID of the sponsoring user to be paid, the user ID of the sponsored user, the commission type, in this case sponsor, and the date extracted from the 106 Multiline MLM Sales Database, in some embodiments the date may be changed to reflect a delay in the processing of the commission or payment of the commission, at step 414. The 108 Multiline MLM Commission Module determines if the user has an upline user by checking the entry for a value in the “Upline User ID” category, if there is no value, or the value does not correspond to a user ID then the 108 Multiline MLM Commission Module will return to polling for a new data entry in the 106 Multiline MLM Sales Database, at step 416. If there is a value that corresponds to a user ID in the “Upline User ID” category, the 108 Multiline MLM Commission Module extracts the commission rule from the 110 Multiline MLM Commission Rule Database for upline users, at step 418. The 108 Multiline MLM Commission Module applies the extracted commission rule to the sales value extracted from the 106 Multiline MLM Sales Database, for example if the rule is 10% commission for upline users and the sales value is $300, then $300 will be multiplied by 10% to get $30 which is the commission payable to the upline user, in some embodiments users may receive a different commission based on how many levels upline they are from the user who made the sale, for example, the upline user of the upline user may earn 5% commission, and next upline user may earn 1% commission, in an embodiment the upline user may be paid directly by the 108 Multiline MLM Commission Module after this step, at step 420. The 108 Multiline MLM Commission Module stores the resulting commission in the 112 Multiline MLM Commission Database along with the user ID of the upline user to be paid, the user ID of the downline user, the commission type, in this case upline, and the date extracted from the 106 Multiline MLM Sales Database, in some embodiments the date may be changed to reflect a delay in the processing of the commission or payment of the commission, at step 422. The 108 Multiline MLM Commission Module then searches the 104 Multiline MLM Multiline User Database for an entry where the user ID in the “User ID” category matches the user ID in the “Upline User ID” category of the currently selected entry. at step 424. The 108 Multiline MLM Commission Module selects the entry with the matching user ID value as the new selected entry and returns to step 408, at step 426.

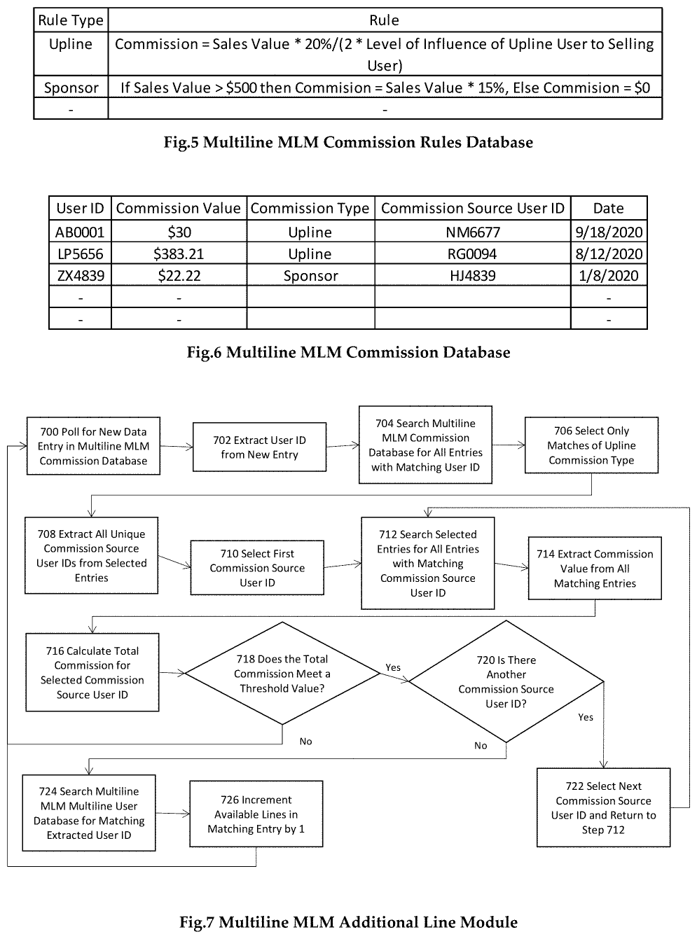

Functioning of the 110 Multiline MLM Commission Rules Database will now be explained with reference to FIG. 5. The 110 Multiline MLM Commission Rules Database contains commission rules which are used by the 108 Multiline MLM Commission Module to determine commissions, commission rules can be complex or simple but will often involve a mathematical calculation, for example, a rule may dictate that commissions for upline users are 10% of the sales value, divided by two for each level above the selling user, meaning that for a $100 dollar sale the upline user will receive $10 the user above them, or 2nd level of influence from the user who made the sale, will receive $5, the user above them will receive $2.50, etc., in another example the rule may dictate that the commission for sponsors is 15% of the sale but only if the sale is over $500, otherwise no commission is paid, the database also contains the type of rule, for example, “Sponsor” which indicates that the rule should be used to calculate commissions for sponsors, in some embodiments multiple rules may exist for one rule type, for example, one rule may apply to sponsors that are also somewhere upline of the user who made the sale, while a different sponsor rule may apply if the sponsor is cross-line, meaning they are not anywhere upline of the user who made the sale, element 500.

Functioning of the 112 Multiline MLM Commission Database will now be explained with reference to FIG. 6. The 112 Multiline MLM Commission Database contains commissions calculated by the 108 Multiline MLM Commission Module which are then used by the 114 Multiline MLM Additional Line Module to determine if the user qualifies for an additional line, in some embodiments this data may be used by another module to pay commissions to users, which comprises at least a user ID, for example, AB0001, a commission value, for example, $30, the type of commission, for example, downline, the user ID of the user the commission came from, for example, NM6677, and a date, for example, Sep. 18, 2020, if the commission came from a sale made somewhere in a user's downline then the commission will be considered to come from the immediately downline user, in other embodiments the commission may be recorded as coming from the selling user, element 600.

Functioning of the 114 Multiline MLM Additional Line Module will now be explained with reference to FIG. 7. The process begins with the 114 Multiline MLM Additional Line Module polling for a new data entry in the 112 Multiline MLM Commission Database at step 700. The 114 Multiline MLM Additional Line Module extracts the user ID from the User ID category in the new data entry, for example, AB0001 at step 702. The 114 Multiline MLM Additional Line Module searches the 112 Multiline MLM Commission Database for all entries that also have the extracted user ID in the User ID category, which is data on all the commissions that have been paid to that user, at step 704. The 114 Multiline MLM Additional Line Module selects all the matching entries that also have “upline” in the Commission Type category, at step 706. The 114 Multiline MLM Additional Line Module extracts all the user IDs in the Commission Source User ID category of the entries, ignoring repeats, each of these user IDs corresponds to a user that is directly downline of the user who's user ID was extracted from the new data entry, and therefore each correspond to a line, in some embodiments, lines that have not yet made sales may be accounted for by creating a null or nominal commission upon creation, for example, if user AB0001 places user CD0002 in their immediate downline a record may be recorded in the 112 Multiline MLM Commission Database for $0.01 or $0.00 so that CD0002 is recognized as the start of one of AB0001's downlines, at step 708. The 114 Multiline MLM Additional Line Module selects the first of the extracted Commission Source User IDs, first may be determined by, for example, alphabetical order or most recent commission, at step 710. The 114 Multiline MLM Additional Line Module searches the entries selected in step 706 for all entries that match the commission source user ID selected in the Commission Source User ID category, which will find all the entries that correspond to commissions made by a single line, at step 712. The 114 Multiline MLM Additional Line Module extracts the commission value in the Commission Value Category for each matching entry, in some embodiments the commissions are further filtered by a time frame, for example, only commission values from commissions made in the last month will be extracted, at step 714. The 114 Multiline MLM Additional Line Module totals the extracted commission values by adding them all together to get the total commission from that line, at step 716. The 114 Multiline MLM Additional Line Module determines if the total commission calculated meets a threshold value, the threshold value is a value that all lines must meet before a user is allowed to have a new line, for example if the user has 7 lines, each line has made over $1000 in commission, and the threshold value is $1000 then the user will be allowed to create and 8th line, the threshold value can be fixed or variable, in an embodiments the threshold value is stored in a database and retrieved by the 114 Multiline MLM Additional Line Module, if the total commission calculated fails to meet the threshold value then the user cannot receive a new line because all lines must meet the threshold value and the 114 Multiline MLM Additional Line Module will return to polling for a new data entry in the 112 Multiline MLM Commission Database, at step 718. If the total commission calculated meets the threshold value, the 114 Multiline MLM Additional Line Module determines if there is another commission source user ID that was extracted in step 708, at step 720. If there is another commission source user ID, the 114 Multiline MLM Additional Line Module selects the next commission source user ID and returns to step 712, at step 722. If there is not another commission source user ID, the 114 Multiline MLM Additional Line Module searches the 104 Multiline MLM Multiline User Database for an entry that matches the user ID extracted from the new entry in step 702 in the User ID category, at step 724. The 114 Multiline MLM Additional Line Module increments the number in the Available Lines category of the matching entry by 1, which allows the user to create one additional line, in some embodiments the number in the Available Lines category of the matching entry may be changed in another way, for example, increased by 2, multiplied by 1.2 and rounded to the nearest whole number, squared, etc. at step 726.

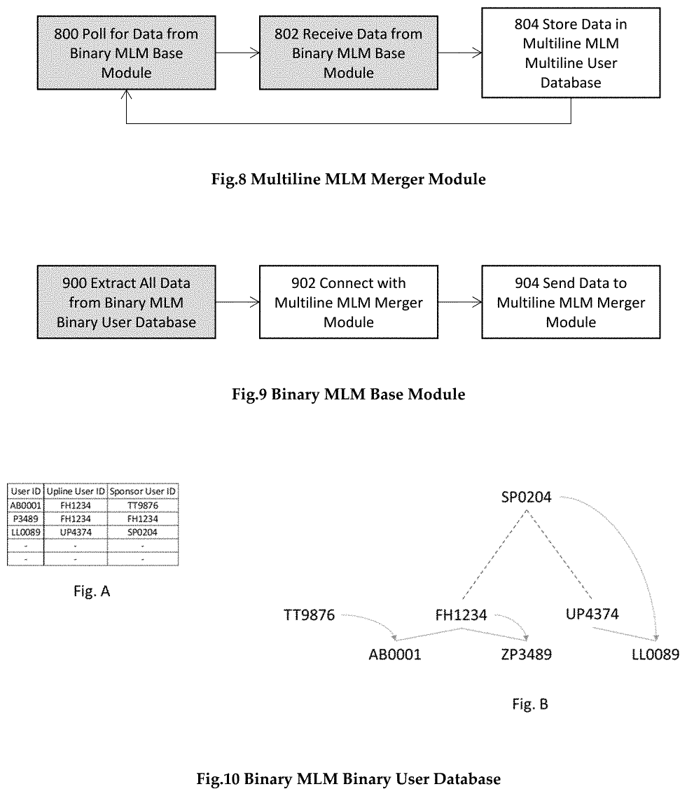

Functioning of the 116 Multiline MLM Merger Module will now be explained with reference to FIG. 8. The process begins with *the 116 Multiline MLM Merger Module polling for data from the 122 Binary MLM Base Module, this data is extracted by the 122 Binary MLM Base Module from the 124 Binary MLM Binary User Database, at step 800. *The 116 Multiline MLM Merger Module receives data from the 122 Binary MLM Base Module, which includes a user ID, for example, AB0001, information on user's position in the Multiline MLM commission structure via the user ID of the user above them in the commission structure, for example, FH1234, who enrolled or sponsored the user in the Multiline MLM, for example, user ID TT9876, and how many lines the user currently has in the Binary MLM, for example, 7, at step 802. *The 116 Multiline MLM Merger Module stores the data as a new entry in the Multiline MLM Multiline Database with the value of 2 in the “Available Lines” category, in an embodiment if the default number of lines in the Multiline MLM is greater than 2 then all members of the Binary MLM will have their number of lines set to the default value, in an embodiment the default number of lines is 4, at step 804.

Functioning of the 122 Binary MLM Base Module will now be explained with reference to FIG. 9. The process begins with *the 122 Binary MLM Base Module extracts all the data stored in the 124 Binary MLM Binary User Database, at step 900. *The 122 Binary MLM Base Module connects with the 116 Multiline MLM Merger Module through the 118 Cloud or Internet, via a physical connection, or by any other method of transferring data, at step 902. *The 122 Binary MLM Base Module sends the data extracted from the 124 Binary MLM Binary User Database to the 116 Multiline MLM Merger Module, at step 904.

Functioning of the 124 Binary MLM Binary User Database″ will now be explained with reference to FIG. 10. *The 124 Binary MLM Binary User Database contains information on user's position in the Binary MLM commission structure, who enrolled or sponsored the user in the Binary MLM, and how many lines the user currently has, which includes a user ID, for example, AB0001, information on user's position in the Multiline MLM commission structure, for example the user ID of the user above them in the commission structure, for example, FH1234, who enrolled or sponsored the user in the Multiline MLM, for example, user ID TT9876, and how many lines the user currently has within the existing Binary MLM, for example, 7, FIG. 10B shows a possible commission structure based on the data in FIG. 10A, wherein the straight lines indicate an upline/downline relationship between two users and a curved, arrowed line indicates that the user the arrow points to was sponsored by the user the line originates from, and the dotted straight line indicates the two users have an indirect upline/downline relationship, meaning there are more users in the line that are not shown, more lines and users may exist than are shown, element 1000.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. *A method for merging a binary MLM into a multiline MLM comprising:
a. providing a multiline MLM with a first set of lines, and b. *providing a binary MLM with a second set of lines, and c. *providing data for at least one member of the binary MLM which contains at least the member's position in the commission structure of the binary MLM, and d. *allowing the data to be used to integrate the at least one member of the binary MLM into the commission structure of the multiline MLM, e. *wherein the at least one member of the binary MLM maintains their downlines after being integrated into the multiline MLM, f. *and wherein the at least one member of the binary MLM may be allowed additional lines.
